(19) United States
(12) Patent Application Publication
(10) Pub. No.: US 2009/0143054 A1
(43) Pub. Date: Jun. 4, 2009

(54) Apparatus and method for automatic adjustment of ring volume based on perceived volume of digital audio playback

(76) Inventors: Peter Drescher, Menlo Park, CA (US); Jarrell Irvin, Mountain View, CA (US)

Correspondence Address: MICROSOFT CORPORATION, ONE MICROSOFT WAY, REDMOND, WA, 98052, US

(21) Appl. No.: 11/512,043

(22) Filed: Aug. 28, 2006

(51) Int. Cl. H04M 3/00; H04M 1/00

(52) U.S. Cl. 455/418; 455/550.1

(57) ABSTRACT

A system and method are for adjusting ringtone volume on a telephony device based on a current user-selected volume level used for digital audio playback. For example, a method according to one embodiment of the invention is implemented within a telephony apparatus having digital audio playback and ringtone playback capabilities, the method comprising: decoding and playing digital audio content in response to user input; monitoring the playback of the digital audio content to determine a first volume level associated with the digital audio content; receiving an incoming telephone call on the telephony apparatus; adjusting a second volume level associated with a currently-selected ringtone based on the value of the first volume level; and playing the currently-selected ringtone at the adjusted second volume level.

### BACKGROUND OF THE INVENTION

1. Field of the Invention

This invention relates generally to the field of data processing devices. More particularly, the invention relates to an apparatus and method for automatically adjusting the ring volume of a telephony device based on the current perceived volume of digital audio playback.

2. Description of the Related Art

Some cellular telephony devices today are equipped with multimedia capabilities. For example, telephones such as the Motorola SLVR L7 allow users to download and play back digital video and audio content (e.g., MP3 and AAC-3 files). In addition, these devices allow the end user to select and download different “ringtones”—i.e., the series of notes rendered by the device upon receipt of an incoming telephone call or electronic message.

These devices typically provide different, independent volume control capabilities for ringtones and digital audio playback. For example, a relatively coarse level of volume control is provided for ringtones based on a small set of predefined volume levels such as, e.g., “very loud,” “loud,” “medium,” “soft,” “very soft,” “off.” By contrast, a relatively fine level of volume adjustment is provided for digital audio playback such as, e.g., selectable volume levels ranging from 0 to 100.

The foregoing configuration can be undesirable in some circumstances. For example, given the independence of the two volume levels, if a user is listening to a digital audio file at a low volume and receives a call, the volume of the ringtone may be too loud, particularly if the ringtone is generated in the user's headphones. By contrast, if the user is listening to digital audio at a relatively high volume and/or if the ringtone is not produced in the user's headphones, the volume of the ringtone may be too soft and therefore not heard by the user

Accordingly, what is needed is a mechanism for controlling the volume of a ringtone based on the current volume of digital audio playback.

### SUMMARY

A system and method are described for adjusting ringtone volume on a telephony device based on a current user-selected volume level used for digital audio playback. For example, a method according to one embodiment of the invention is implemented within a telephony apparatus having digital audio playback and ringtone playback capabilities, the method comprising: decoding and playing digital audio content in response to user input; monitoring the playback of the digital audio content to determine a first volume level associated with the digital audio content; receiving an incoming telephone call on the telephony apparatus; adjusting a second volume level associated with a currently-selected ringtone based on the value of the first volume level; and playing the currently-selected ringtone at the adjusted second volume level.

### BRIEF DESCRIPTION OF THE DRAWINGS

A better understanding of the present invention can be obtained from the following detailed description in conjunction with the following drawings, in which:

FIG. 1 illustrates a high level architecture according to one embodiment of the invention.

FIG. 2a-2b illustrates the manner in which ringtone volume is adjusted based on the current volume of a digital audio file according to one embodiment of the invention.

FIG. 3 illustrates a system architecture according to one embodiment of the invention.

FIG. 4 illustrates an architecture of a data processing telephony device according to one embodiment of the invention.

### DETAILED DESCRIPTION OF PREFERRED EMBODIMENTS

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

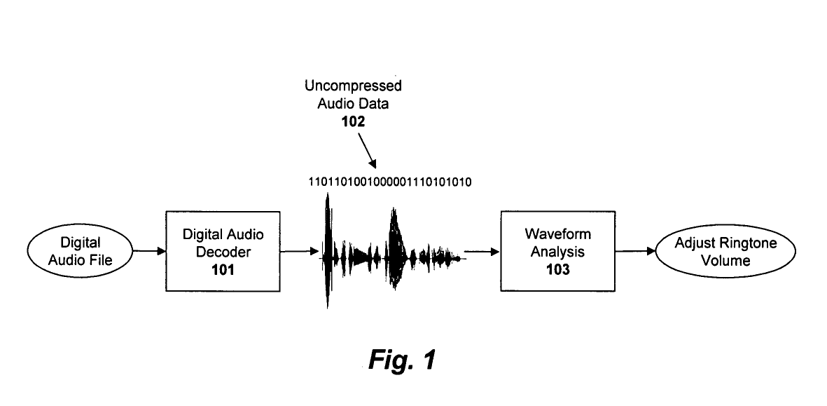

FIG. 1 illustrates one embodiment of a system for controlling ringtone volume based on the current digital audio volume. As illustrated, in this embodiment, a digital audio decoder module 101 (e.g., an MP3 decoder) decodes audio data contained within a digital audio file to generate a stream of uncompressed audio data 102. A waveform analysis module 103 continuously monitors the current volume of the uncompressed digital audio 102 and, in response, adjusts the current ringtone volume of the telephony device.

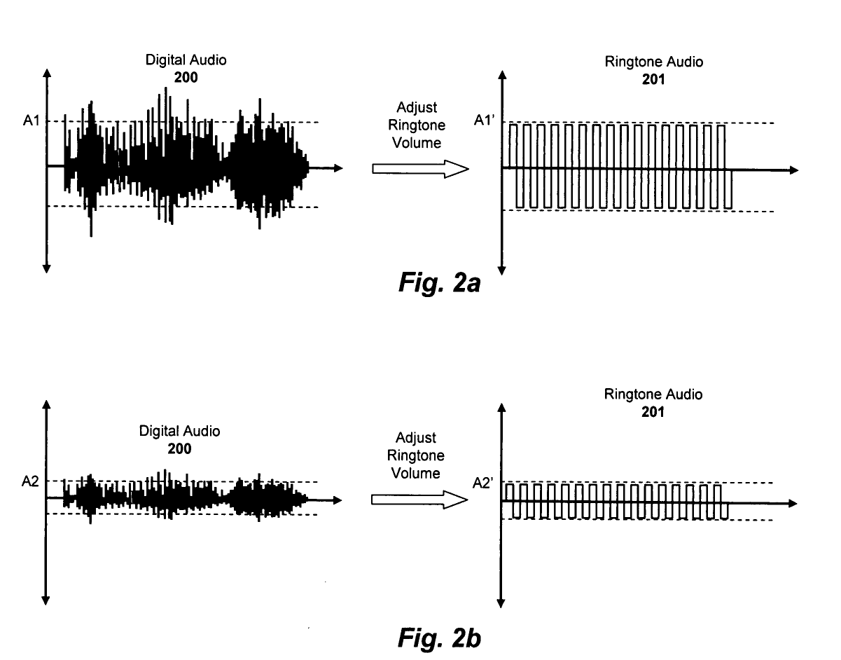

This is graphically illustrated in FIGS. 2a-b. Specifically, FIG. 2a shows a digital audio waveform 200 rendered at an average volume level A1. In response to detecting the average volume A1 of the waveform, the waveform analysis module 103 causes the ringtone volume to be set to volume level A1′, as illustrated. Subsequently, when the average volume of the digital audio drops to A2, the waveform analysis module 103 causes the ringtone volume to be dropped down to A2₁. Thus, if the end user receives a call while listening to music, the ringtone volume will be automatically set at a reasonable level based on the current volume of the music.

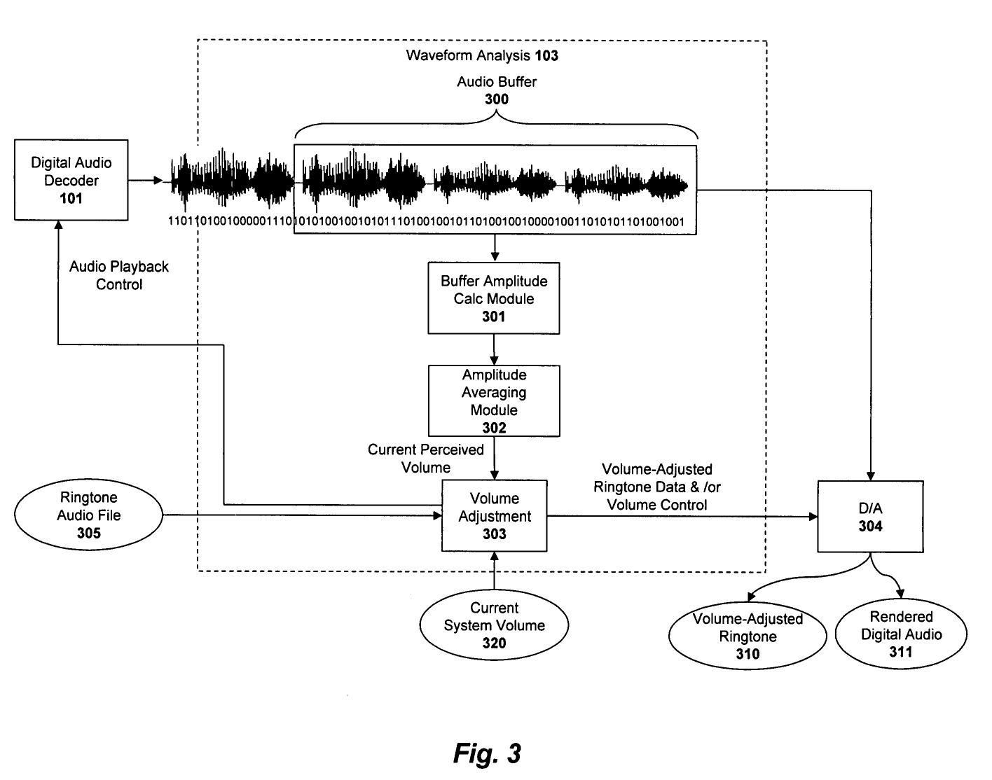

FIG. 3 illustrates additional details related to the waveform processing module 102. Specifically, in this embodiment of the invention, a buffer amplitude calculation module 301 reads the uncompressed audio data from an audio buffer 300 and calculates a number that represents the volume of that buffer of uncompressed digital audio over a specified time period, namely the length in time of that buffer (e.g., once every 1/50 second). Various well known algorithms may be used to calculate this number. It may be a simple peak, which is the loudest volume (highest absolute value number). Alternatively it may be an average volume, such as root-mean squared (“RMS”) average volume. RMS is a well known algorithm that takes each volume level and squares it, averages those volumes (i.e., adds them together and divides by the number of volume levels) and then takes the square root of the result.

Regardless of how the buffer volume is calculated, a second module, the amplitude averaging module 302 periodically calculates an average of buffer amplitudes to obtained a perceived volume. The amplitude averaging module 302 may perform this calculation each time the buffer amplitude is calculated (e.g., once every 1/50 second, ½ second, once every second, etc), every 2-10 seconds, or simply on demand. The calculation may be done via a running average of buffer volumes, where only the most recent buffer volumes are used (e.g. the last 5 seconds worth of buffer volumes). In this way, the average perceived recent volume is obtained (i.e., a value representing how loud it sounds in the last N seconds).

At this point, whenever a ringtone needs to be played, a system volume adjustment module 303 reads the current perceived module provided by the amplitude averaging module 302 and uses this information to set the ringtone volume. In one embodiment, the system volume adjustment module 303 uses the current perceived volume in conjunction with the system volume 320 to determine how to adjust the ringtone volume (i.e., the current system volume may be read from memory). For example, the user may set the system volume 320 to soft, and have digital audio playback set to “loud.” In this case, the system volume adjustment module 303 may set the volume of the ringtone close to the perceived volume of the digital audio playback, but just a little softer (i.e., within a predetermined range of the perceived volume of the digital audio playback).

In one embodiment, the volume adjustment module 303 causes the digital audio playback to stop before playing the ringtone (as indicated by the audio playback control line to the digital audio decoder module 101). Alternatively, if digital audio playback continues, it may continue to play at the same volume but the ringtone volume should be set so that it can be heard above the digital audio playback. In addition, the volume adjustment module 303 may cause volume of the music to be reduced by a specified amount, a process know as “ducking,” so that the ringtone can be heard more clearly. In this embodiment, a precalculated average volume of the ringtone may be used to either further adjust the volume of the ringtone or the music. Even if the volume adjustment module 303 causes the digital audio playback to stop before playing the ringtone, in one embodiment, the volume adjustment module 303 still uses the precalculated average volume of the ringtone to further adjust the volume of the ringtone.

In summary, the perceived average volume of the music is used to adjust the volume of the ringtone. This may be the only factor used to set the ringtone volume, or it may be combined with other factors such as the system volume or a precalculated average volume of the ringtone.

Both the digital audio content and the ringtone data (with adjusted volume) are converted to analog audio signals 311 and 310, respectively, by a digital-to-analog (D/A) converter module 304. In one embodiment, rather than adjusting the ringtone volume digitally, the volume adjustment module 303 causes the D/A conversion module 304 to adjust the ringtone volume of the analog ringtone signal 310 and/or the digital audio signal 311 by communicating a current desired volume level for each of these signals. The D/A conversion process is very well known and the particular type of D/A conversion module 304 used is not relevant to the underlying principles of the invention.

The various functional modules illustrated in FIG. 1 and FIG. 3 may be implemented as hardware, software or any combination thereof. For example, in one embodiment, the audio signal processing described above is implemented using a programmable audio chip with digital signal processing (DSP) capabilities.

In addition, the underlying principles of the invention may be implemented using virtually any type of digital audio content and/or ringtone content including, by way of example and not limitation, MP3 files, MPEG-4 Audio files, musical instrument digital interface (“MIDI”) files, Windows® Media files, and Real Audio® files.

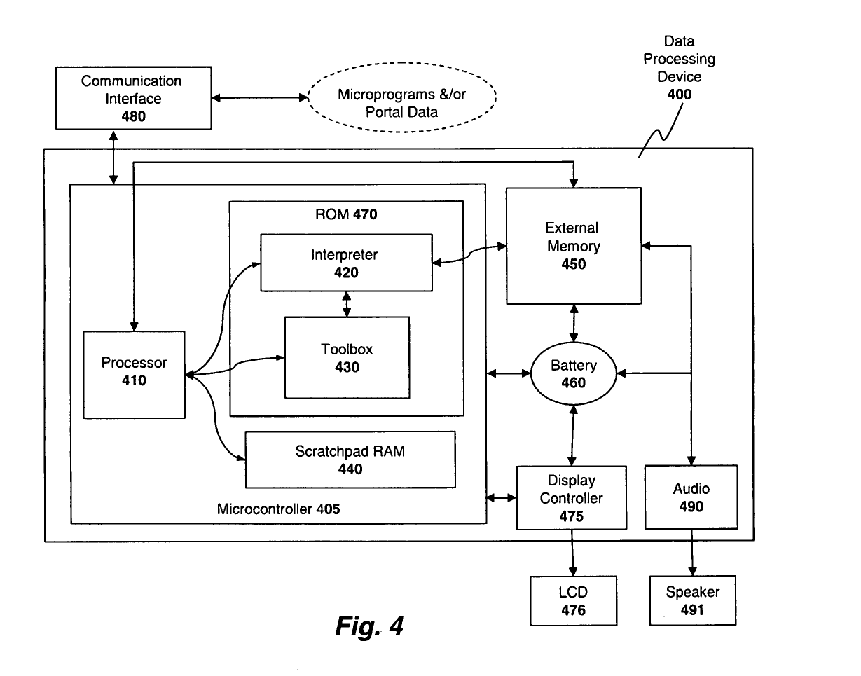

One embodiment of a telephony device architecture is illustrated in FIG. 4. It should be noted, however, that the underlying principles of the invention are not limited to any particular hardware or software architecture. In fact, the underlying principles of the invention may be implemented on virtually any telephony device capable of generating ringtones in response to telephone calls and rendering digital audio content.

The particular embodiment illustrated in FIG. 4 is comprised of a microcontroller 405, an external memory 450, a display controller 475, and a battery 460. The external memory 450 may be used to store programs and/or data 465 transmitted to the data processing device 100 over a network (not shown). In one embodiment, the external memory 450 is non-volatile memory (e.g., an electrically erasable programmable read only memory (“EEPROM”); a programmable read only memory (“PROM”), . . . etc). Alternatively, the memory 450 may be a volatile memory (e.g., random access memory or “RAM”) but the data stored therein may be continually maintained via the battery 460. The battery 460 in one embodiment is a coin cell battery such as those used in calculators and watches.

The microcontroller 405 of one embodiment is comprised of a central processing unit (“CPU”) 410, a read only memory (“ROM”) 470, and a scratchpad RAM 440. The ROM 470 is further comprised of an interpreter module 420 and a toolbox module 430.

The toolbox module 430 of the ROM 470 contains a set of toolbox routines for processing data, text and graphics on the device 100. These routines include drawing text and graphics on the device's display 430, decompressing data transmitted from the portal server 110, reproducing audio on the device 100, and performing various input/output and communication functions (e.g., transmitting/receiving data over the client link 10 and/or the RF link 220). A variety of additional device functions may be included within the toolbox 430 while still complying with the underlying principles of the invention.

In one embodiment, microprograms and data are transmitted to/from the external memory 450 of the device via a communication interface 470 under control of the CPU 410. Various communication interfaces 470 may be employed without departing from the underlying principles of the invention including, for example, a Universal Serial Bus (“USB”) interface or a serial communication (“serial”) interface. The microprograms in one embodiment are comprised of compact, interpreted instructions known as “bytecodes,” which are converted into native code by the interpreter module 420 before being executed by the CPU 410. One of the benefits of this configuration is that when the microcontroller/CPU portion of the device 100 is upgraded (e.g., to a faster and/or less expensive model), only the interpreter module 420 and toolbox 430 of the ROM needs to be rewritten to interpret the currently existing bytecodes for the new microcontroller/CPU. In addition, this configuration allows devices with different CPUs to coexist and execute the same microprograms. Moreover, programming frequently-used routines in the ROM toolbox module 430 reduces the size of microprograms stored in the external memory 450, thereby conserving memory and bandwidth over the client link 10 and/or the RF link 220. In one embodiment, new interpreter modules 420 and/or toolbox routines 430 may be developed to execute the same microprograms on cellular phones, personal information managers (“PIMs”), or any other device with a CPU and memory.

One embodiment of the ROM 470 is comprised of interpreted code as well as native code written specifically for the microcontroller CPU 405. More particularly, some toolbox routines may be written as interpreted code (as indicated by the arrow between the toolbox 430 and the interpreter module 420) to conserve memory and bandwidth for the same reasons described above with respect to microprograms. Moreover, in one embodiment, data and microprograms stored in external memory 450 may be configured to override older versions of data/microprograms stored in the ROM 470 (e.g., in the ROM toolbox 430).

The embodiment shown in FIG. 4 also includes an audio processing chip 490 for implementing the audio processing techniques described above. For example, in one embodiment, the audio processing chip 490 includes digital signal processing logic for implementing the functions of the digital audio decoder 101, waveform analysis module 103 and/or D/A converter 304. Alternatively, the functions performed by these modules may be implemented (at least in part) by the processor 410. In one embodiment, the audio chip is the TSC2111/AIC29 made by Texas Instruments, Inc., and referred to commonly as the AIC29. However, the underlying principles of the invention are not limited to any particular audio processing hardware.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, while the embodiments described above employ specific techniques for measuring the average volume level of audio, the underlying principles of the invention are not limited to any particular techniques. Accordingly, the scope and spirit of the invention should be judged in terms of the claims which follow.

1. A method implemented within a telephony apparatus having digital audio playback and ringtone playback capabilities:
playing digital audio content in response to user input;
monitoring the playback of the digital audio content to determine a first volume level associated with the digital audio content;
receiving an incoming telephone call on the telephony apparatus;
adjusting a second volume level associated with a currently-selected ringtone based on the value of the first volume level; and
playing the currently-selected ringtone at the adjusted second volume level.

2. The method as in claim 1 wherein monitoring the playback of the digital audio content to determine a first volume level comprises:
calculating an average volume level of the digital audio content over a specified time period.

3. The method as in claim 1 wherein the digital audio content comprises an MP-3 file.

4. The method as in claim 1 wherein adjusting the second volume level is adjusted to equal the first volume level.

5. The method as in claim 1 wherein the telephone call is received over a cellular telephone network.

6. The method as in claim 1 playing the ringtone comprises playing the ringtone concurrently with the digital audio content.

7. The method as in claim 6 wherein playing the ringtone and digital audio content comprises:
decoding the ringtone and/or digital audio content to generate uncompressed digital audio content; and
performing digital to analog conversion to generate an analog audio signal comprising both the ringtone and the digital audio content.

8. A telephony apparatus having digital audio playback and ringtone playback capabilities comprising:
a decoder to play back digital audio content in response to user input;
a waveform analysis module to monitor the playback of the digital audio content and to determine a first volume level associated with the digital audio content;
a telephony transmitter/receiver to receive an incoming telephone call on the telephony apparatus;
a volume adjustment module to adjust a second volume level associated with a currently-selected ringtone based on the value of the first volume level; and
a digital-to-analog conversion module to play the currently-selected ringtone at the adjusted second volume level.

9. The system as in claim 8 wherein monitoring the playback of the digital audio content to determine a first volume level comprises:
calculating an average volume level of the digital audio content over a specified time period.

10. The system as in claim 8 wherein the decoder is an MP-3 decoder and the digital audio content comprises an MP-3 file.

11. The system as in claim 8 wherein adjusting the second volume level is adjusted to equal the first volume level.

12. The system as in claim 8 wherein the telephony transmitter/receiver is a cellular telephony receiver and the telephone call is received over a cellular telephone network.

13. The system as in claim 8 playing the ringtone comprises playing the ringtone concurrently with the digital audio content.

14. The system as in claim 13 wherein playing the ringtone and digital audio content comprises:
decoding the ringtone and/or digital audio content to generate uncompressed digital audio content; and
performing digital to analog conversion to generate an analog audio signal comprising both the ringtone and the digital audio content.
